(19) United States
(12) Patent Application Publication
(10) Pub. No.: US 2016/0144800 A1
(43) Pub. Date: May 26, 2016

(54) COLLAPSIBLE CARGO MAT ORGANIZER

(71) Applicant: Toyota Tsusho America, Inc., New York, NY (US)

(72) Inventors: Brian E. Henderson, Farmington Hills, MI (US); Donald L. Munoz, Bloomfield Hills, MI (US); Nickoli Moskatow, Clinton TWP, MI (US); Tyler J. Crook, Hazel Park, MI (US)

(21) Appl. No.: 14/948,967

(22) Filed: Nov. 23, 2015

Related U.S. Application Data
(60) Provisional application No. 62/084,675, filed on Nov. 26, 2014.

(51) Int. Cl. B60R 13/01; B60R 5/04

(52) U.S. Cl. CPC B60R 13/013; B60R 5/04; B60R 2013/016

(57) ABSTRACT

A collapsible cargo mat organizer includes a base, a first sidewall and a first end wall. The first sidewall includes a bottom edge hingeably connected to the base and a top edge opposite the bottom edge. The first end wall includes a first core panel hingeably connected to the first sidewall and a second core panel hingeably connected to the first core panel and having a bottom edge abutting the base. The first sidewall is pivotable between a closed position, wherein the top edge of the first sidewall is positioned adjacent the base, and an open position, wherein the top edge of the first sidewall is displaced from the base.

### RELATED APPLICATIONS

This application claims benefit of U.S. Provisional Application No. 62/084,675, filed on Nov. 26, 2014, which is herein incorporated by reference in its entirety.

### BACKGROUND

Automotive vehicles may include various storage compartments for transporting objects. For example, a sedan type vehicle may include an enclosed trunk space separate from a passenger compartment of the vehicle. A vehicle, such as a sport utility vehicle (SUV) or van may include a storage area located behind a rear passenger seat that is open to the passenger compartment. The vehicle may include features that enable the storage compartment to be subdivided into smaller compartments to enhance usability of the available storage space and better secure objects within the vehicle. However, it may not be possible or convenient to convert the sub-divided storage space to a larger storage space or the mechanism for subdividing the storage compartment may occupy valuable storage space and/or interfere with use of the space.

### SUMMARY

Disclosed are embodiments of a collapsible cargo mat organizer In one aspect, a collapsible cargo mat organizer includes a base, a first sidewall and a first end wall. The first sidewall includes a bottom edge hingeably connected to the base and a top edge opposite the bottom edge. The first end wall includes a first core panel hingeably connected to the first sidewall and a second core panel hingeably connected to the first core panel and having a bottom edge abutting the base. The first sidewall is pivotable between a closed position, wherein the top edge of the first sidewall is positioned adjacent the base, and an open position, wherein the top edge of the first sidewall is displaced from the base.

In another aspect, a collapsible cargo mat organizer includes a base, a first sidewall and a first end wall. The base includes a recessed region. The first sidewall includes a bottom edge hingeably connected to the base adjacent a perimeter of the recessed region and a top edge opposite the bottom edge. The first end wall includes a first core panel hingeably connected to the first sidewall and a second core panel hingeably connected to the first core panel and having a bottom edge abutting the base. The first sidewall is pivotable between a closed position, wherein the top edge of the first sidewall is positioned adjacent the base, the second core panel is disposed within the recessed region and a top edge of the first core panel is aligned substantially parallel with the top edge of the first sidewall, and an open position, wherein the top edge of the first sidewall is displaced from the base.

These and other aspects will be described in additional detail below.

### BRIEF DESCRIPTION OF THE DRAWINGS

The various features, advantages and other uses of the present apparatus will become more apparent by referring to the following detailed description and drawings, in which:

FIG. 1 is a schematic perspective view of an exemplary collapsible cargo mat organizer arranged in an open position;

FIG. 2 is a cross-sectional view of the cargo mat organizer taken along section line 2-2 of FIG. 1;

FIG. 3 is an enlarged partial cross-sectional view of a portion of the cargo mat organizer identified as 3 in FIG. 2;

FIG. 4 is an enlarged partial cross-sectional view of a portion of the cargo mat organizer identified as 4 in FIG. 2;

FIG. 5 is an enlarged partial cross-sectional view of a portion of the cargo mat organizer identified as 5 in FIG. 2;

FIG. 6 is an enlarged partial cross-sectional view of a portion of the cargo mat organizer identified as 6 in FIG. 2;

FIG. 7 is a cross-sectional view of the collapsible cargo mat organizer taken along section line 7-7 of FIG. 1;

FIG. 8 is an enlarged partial cross-sectional view of a portion of the cargo mat organizer taken along section line 8-8 of FIG. 1;

FIG. 9 is an enlarged partial cross-sectional view of a portion of the cargo mat organizer identified as 9 in FIG. 7;

FIG. 10 is an enlarged partial cross-sectional view of a portion of the cargo mat organizer identified as 10 in FIG. 7;

FIG. 11 is a schematic perspective view of the cargo mat organizer with a first primary storage compartment arranged in an open position and a second primary storage compartment arranged in a closed position;

FIG. 12 is an alternate perspective view of the cargo mat organizer of FIG. 11;

FIG. 13 is a schematic perspective view of the cargo mat organizer with the first and second primary storage compartments arranged in the closed position;

FIG. 14 is a cross-sectional view of the cargo mat organizer taken along section line 14-14 of FIG. 13;

FIG. 15 is an enlarged partial cross-sectional view of a portion of the cargo mat organizer identified as 15 in FIG. 14;

FIG. 16 is a schematic perspective view of the cargo mat organizer with the first primary storage compartment arranged in an intermediate position between the open and closed positions and the second primary storage compartment arranged in the open position; and

FIG. 17 is an alternate perspective view of the cargo mat organizer of FIG. 16.

### DETAILED DESCRIPTION

Disclosed is a cargo mat organizer for securing objects in a trunk, rear compartment, or other interior space of an automotive vehicle. The cargo mat organizer may include one or more collapsible primary storage compartments individually moveable between an open position and closed position. Interconnected walls define an interior space for retaining objects with the primary storage compartments. The walls may be selectively folded down generally flush with a surrounding portion of the cargo mat organizer when the primary storage compartment is arranged in the closed position.

Referring now to the discussion that follows and also to the drawings, illustrative approaches to the disclosed systems and methods are shown in detail. Although the drawings represent some possible approaches, the drawings are not necessarily to scale and certain features may be exaggerated, removed, or partially sectioned to better illustrate and explain the present invention. Further, the descriptions set forth herein are not intended to be exhaustive or otherwise limit or restrict the claims to the precise forms and configurations shown in the drawings and disclosed in the following detailed description.

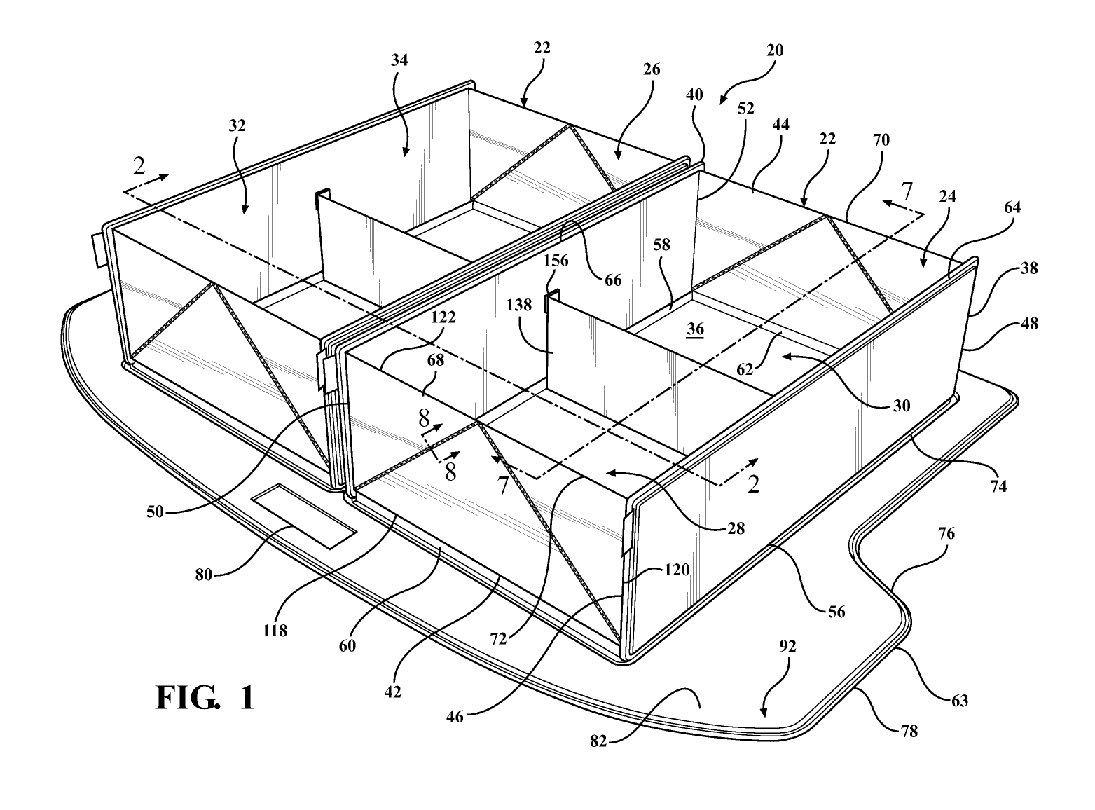

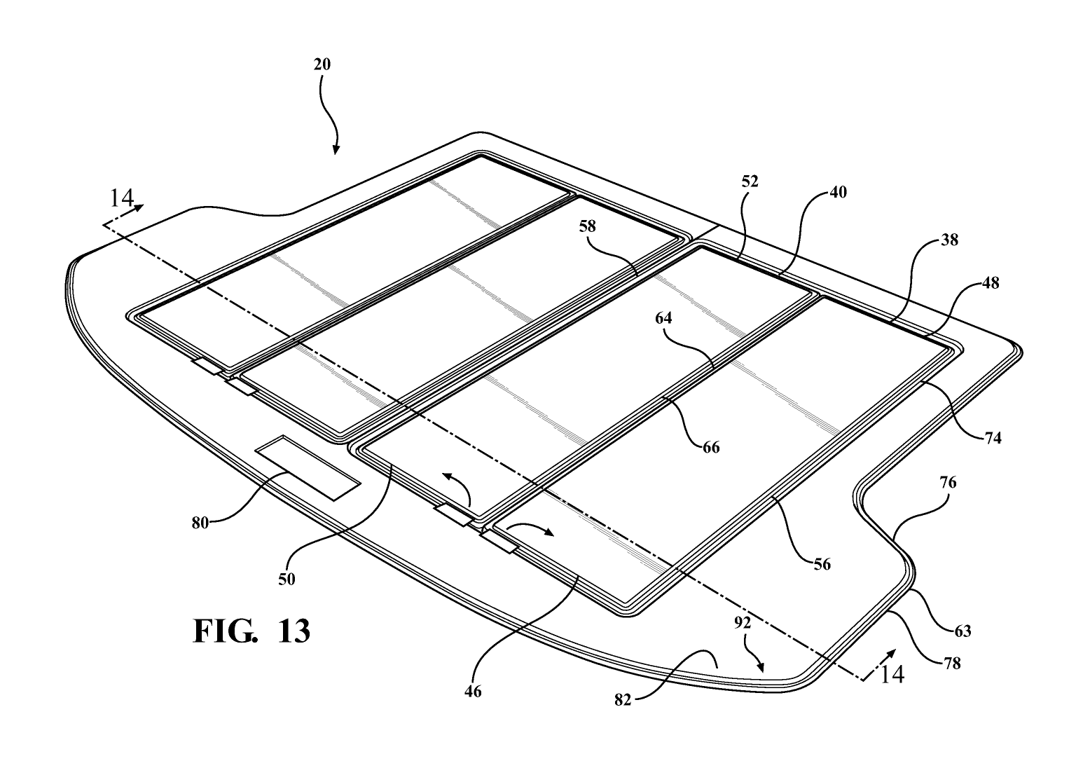

With reference to FIG. 1, an exemplary cargo mat organizer 20 may include one or more generally rectangular-shaped storage compartments 22 for securing objects within an interior of a vehicle. The illustrated exemplary configuration of storage compartment 22 includes two primary storage compartments; a first primary storage compartment 24 and a second primary storage compartment 26 positioned adjacent the first primary storage compartment 24. In practice cargo mat organizer 20 may include fewer or more primary storage compartments. The number of primary storage compartments and their arrangement relative to one another may be varied to suit the design and performance requirements of a particular application. Each primary storage compartment may be selectively moved between and open position, as illustrated, for example, in FIG. 1, and a closed position, as illustrated, for example, in FIG. 13.

The first and second primary storage compartments 24 and 26 may be subdivided into one or more secondary storage compartments. For example, first primary storage compartment 24 may include a first secondary storage compartment 28 and a second secondary storage compartment 30. Second primary storage compartment 26 may be similarly subdivided into a first secondary storage compartment 32 and a second secondary storage compartment 34. Each primary storage compartment 24 and 26 may be alternatively subdivided into multiple secondary storage compartments, or may be configured not to include any secondary storage compartments. It is not necessary that all primary storage compartments have an equal number of secondary storage compartments, and a primary storage compartment may have fewer or more secondary storage compartments than another primary storage compartment.

First primary storage compartment 24 and second primary storage compartment 26 may have substantially similar configurations. As such, for purposes expediency the configuration of first primary storage compartment 24 will be described, with the understanding that second primary storage compartment 26 may be substantially similarly configured.

With continued reference to FIG. 1, first primary storage compartment 24 may include a generally rectangular-shaped interior region 36 for receiving and storing objects. Interior region 36 may be bounded by four walls, each of which may be selectively pivoted between the open position (e.g., FIG. 1) and the closed position (e.g., FIG. 13). The walls may include a first sidewall 38 and a second sidewall 40 arranged opposite and spaced apart from first sidewall 38. A first end wall 42 may extend between first sidewall 38 and second sidewall 40. A second end wall 44 may be arranged opposite and spaced apart from first end wall 42, and extend between first sidewall 38 and second sidewall 40. A first end 46 of first sidewall 38 may be hingeably attached to first end wall 42 and an opposite second end 48 may be hingeably attached to second end wall 44. Similarly, a first end 50 of second sidewall 40 may be hingeably connected to first end wall 42 and an opposite second end 52 may be hingeably connected to second end wall 44.

Each wall 38, 40, 42 and 44 includes a respective bottom edge 56, 58, 60 and 62, hingeably connected to a base 63. The walls further include a top edge 64, 66, 68 and 70 opposite the corresponding bottom edges 56, 58, 60 and 62, respectively. The top edges 64, 66, 68 and 70 generally define an outer perimeter of an opening 72 in first primary storage compartment 24 when arranged in the open position. Opening 72 provides access to interior region 36 of first primary storage compartment 24.

Base 63 may overlay a surface of a vehicle when cargo mat organizer 20 is arranged in the vehicle. The vehicle surface may include, for example, a floor or other generally horizontal surface of a trunk space, rear compartment or other interior vehicle space. The vehicle surface may also include an exterior surface, for example, a bed or exterior cargo space of a vehicle, such as a pickup truck.

At least a portion of base 63 may extend beyond an outer perimeter 74 of interior region 36 defined by walls 38, 40, 42 and 44 of first primary storage compartment 24. An outer perimeter 76 of base 63 includes an edge 78. Edge 78 may be configured to include various contours to accommodate surface features of the vehicle and provide an integrated custom appearance and feel to cargo mat organizer 20. Base 63 may alternatively be configured to have substantially the same size and shape as first and second primary storage compartments 24 and 26, with little or no portion of the base 63 extending beyond the outer perimeter of the primary storage compartments. Base 63 may include a region 80 for positioning a badge, emblem or other manufacturer or retailer designation or symbol. Region 80 may be recessed or positioned flush with an upper surface 82 of base 63.

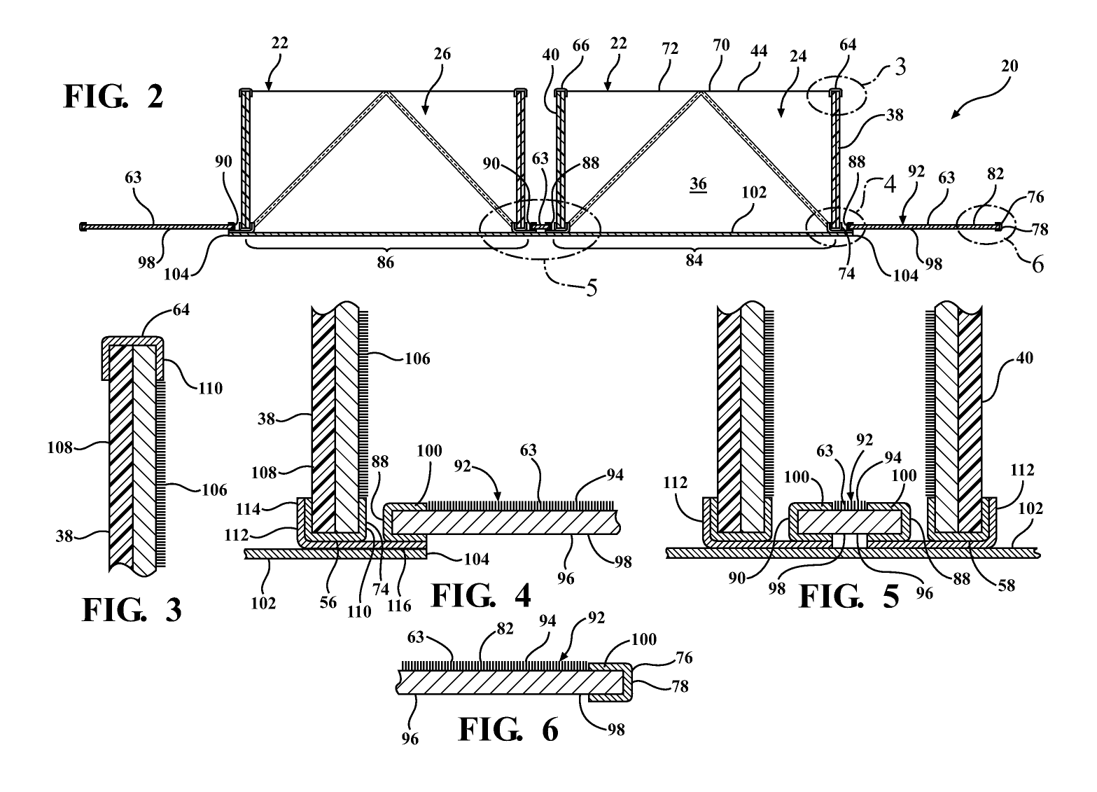

With reference to FIGS. 2-5, base 63 may include one or more openings coinciding with first and second primary storage compartments 24 and 26. For example, base 63 may include a first opening 84 generally coinciding with first primary storage compartment 24 and a second opening generally coinciding with second primary storage compartment 26. A perimeter of first opening 84 is defined by an edge 88 and a perimeter of second opening 86 is defined by an edge 90. First opening 84 may be sized larger than first primary storage compartment 24, such that edge 88 extends around an outer perimeter of first primary storage compartment 24. Similarly, second opening 86 may be sized larger than second primary storage compartment 26, such that edge 90 extends around an outer perimeter of second primary storage compartment 26.

With reference to FIGS. 1 and 4-6, base 63 may include a carpet 92 having a layer of pile 94 attached to a backing 96. Base 63 may alternatively include other configurations and materials. For example, carpet 92 may include a rubber backing applied to an underside 98 of base 63 that rests on the vehicle surface. Base 63 may also be constructed partially or entirely from various generally flexible materials, such as rubber. It is not necessary that base 63 include carpet 92.

Various techniques and mechanisms may be employed for finishing the edges of carpet 92 to help prevent fraying or unraveling of pile 94 and backing 96 and provide an aesthetically pleasing finished appearance. Finishing material may be applied to the exposed edges of carpet 92, including edge 88 of first opening 84, edge 90 of second opening 86 and edge 78 of base outer perimeter 76. Finishing options may include applying a binding 100 to the exposed edges (e.g., edges 78, 88 and 90) of base 63. Binding 100 may be wrapped around the exposed edges of carpet 92 and secured in place by stitching or another suitable attachment mechanism, such as an adhesive. Binding 100 may be made from various materials, including but not limited to, polyester and cotton, as well as other suitable materials. Alternatively, serging may be applied to the exposed edges of carpet 92. Serging typically includes wrapping a thick fiber thread around the exposed edges of the carpet 92. Other finishing techniques may also be employed for protecting the exposed edges of carpet 92.

With reference to FIGS. 2, 4, 7 and 9, a pad 108 may be positioned across first opening 84 and second opening 86 in base 63. Pad 102 may be attached to underside 98 of base 63 along a perimeter 104. Stitching, adhesive or another connection method may be used to secure pad 102 to base 63. Pad 102 may be sized to entirely cover openings 84 and 86 in base 63, and may cover a portion or an entire underside 98 of base 63. Pad 102 may be constructed from a generally flexible material, and may include a woven material made of nylon, cotton, polyethylene, or another material. Pad 102 may alternatively be constructed from a continuous sheet of generally flexible material.

First sidewall 38 and second sidewall 40 may be similarly configured. For purposes of expediency, the configuration of first sidewall 38 will be described, with the understanding that second sidewall 40 may be similarly constructed. With reference FIGS. 2-4, first sidewall 38 may include a layer of carpet 106 attached to a backing pad 108. Carpet 106 and backing pad 108 may be similarly sized, or one may be sized larger or smaller than the other. Carpet 106 may be similarly constructed as carpet 80 of base 63, and may include a layer of pile attached to a backing. Backing pad 108 may be constructed from a flexible resilient material, such as rubber. A finishing material may be applied to the exposed edges of first sidewall 38. Finishing options may include applying a binding 110 to the exposed edges of first sidewall 38. Binding 110 may be wrapped around the exposed edges of first sidewall 38 and secured in place by stitching or another suitable attachment mechanism, such as an adhesive. Binding 110 may be made from various materials, including but not limited to polyester and cotton, as well as other suitable materials. Alternatively, serging may be applied to the exposed edges of first sidewall 38. Serging may include wrapping a thick fiber thread around the exposed edges of first sidewall 38. Other finishing techniques may also be employed for protecting the exposed edges of first sidewall 38. To provide continuity, first and second sidewalls 38 and 40 and base 63 may employ similar edge finishing.

With reference to FIGS. 4 and 5, first and second sidewalls 38 and 40 may be hingeably connected to base 63. A flexible hinge 112 may be used to connect bottom edge 56 of first sidewall 38 and bottom edge 58 of second sidewall 40 to base 63. For purposes of expediency, the hinge mechanism for attaching first sidewall 38 to base 63 will be described, with the understanding that second sidewall 40 may be similarly connected to base 63 using a second hinge 112. Hinge 112 may include various configurations. With particular reference to FIG. 4, hinge 112 may include a flexible material having a first end 114 attached to bottom edge 56 of first sidewall 38 and a second end 116 attached to base 63. Hinge 112 may be secured in place by stitching or another suitable attachment mechanism, such as an adhesive. Hinge 112 may be constructed from a generally flexible resilient fabric, for example, a woven nylon material. Hinge 112 may extend an entire length of bottom edge 56 of first sidewall 38, or only a portion of the bottom edge. Hinge 112 may be positioned between pad 102 attached to base 63 and binding 100 attached to the edges of first and second openings 84 and 86 in base 63. A single stitching operation may be used to attach pad 102 and hinge 112 to base 63.

First end wall 42 and second end wall 44 may be similarly configured. For purposes of expediency, the configuration of first end wall 42 will be described, with the understanding that second end wall 44 may be similarly configured. With reference to FIGS. 1 and 7-9, first end wall 42 may include three separate generally triangular-shaped core panels 118, 120 and 122, arranged edge-to-edge to form the rectangular-shaped first end wall 42. Each core panel 118, 120 and 122 may be constructed from a rigid or semi-rigid material, such as high-density polyethylene (HDPE).

A generally flexible cover 124 may overlay the three core panels 118, 120 and 122. Both an inner surface 126 and an outer surface 128 of core panels 118, 120 and 122 may be covered by cover 124. Cover 124 may be secured in place by stitching 130 along an outer circumference of the core panels 118, 120 and 122 and between adjacent core panels. Stitching 130 between adjacent core panels 118, 120 and 122 creates a hinge joint 132 that allows core panels 118, 120 and 122 to pivot about hinge joint 132 relative to one another. Cover 124 may also or alternatively be fixedly attached to core panels 118, 120 and 124, for example, with an adhesive.

Cover 124 may be constructed from a flexible material, such as woven nylon. Other woven and non-woven materials, for example materials formed as a flexible continuous sheet, may also be employed. It is not necessary that cover 124 be applied to both inner surface 126 and outer surface 128 of core panels 118, 120 and 122, and alternatively only one of the inner and outer surfaces 126 and 128 may be covered by cover 124.

First and second end walls 42 and 44 may also be configured to not include cover 124. In that configuration the hinge joint between adjacent core panels may be formed, for example, by connecting adjoining core panels with a strip of flexible material arranged along the adjoining edges of the core panels to form a flexible hinge. The flexible hinge material may be attached to the core panel by stitching, adhesive, or another suitable attaching mechanism.

First end wall 42 may be hingeably connected to first and second sidewalls 38 and 40, with core panel 120 hingeably connected to first sidewall 38 and core panel 122 hingeably connected to second sidewall 40, and bottom edge 60 of first end wall 42 at core panel 118 abutting base 63.

Optionally, first end wall 42 may be hingeably connected to base 63 at bottom edge 60 of first end wall 42. With reference to FIG. 9, a flexible hinge 134 may be used to connect bottom edge 60 of first end wall 42 to base 63. For purposes of expediency, the hinge mechanism for attaching first end wall 42 to base 63 will be described, with the understanding that second end wall 44 may be similarly connected to base 63 using a second hinge 134. Hinge 134 may include various configurations. For example, hinge 134 may be formed by extending cover 124 beyond bottom edge 60. An end 136 of the excess cover material forming hinge 134 may be attached to base 63 by stitching or another suitable attachment mechanism, such as an adhesive. Alternatively, hinge 134 may be constructed from a generally flexible resilient fabric, for example, a woven nylon material having one end attached to first end wall 42 and an opposite end attached to base 63. Hinge 134 may extend an entire length of bottom edge 60 of first end wall 42, or only a portion of the bottom edge. Hinge 134 may be positioned between pad 102 attached to base 63 and binding 100 attached to the edges of first and second openings 84 and 86 in base 63. A single stitching operation may be used to attach pad 102 and hinge 134 to base 63.

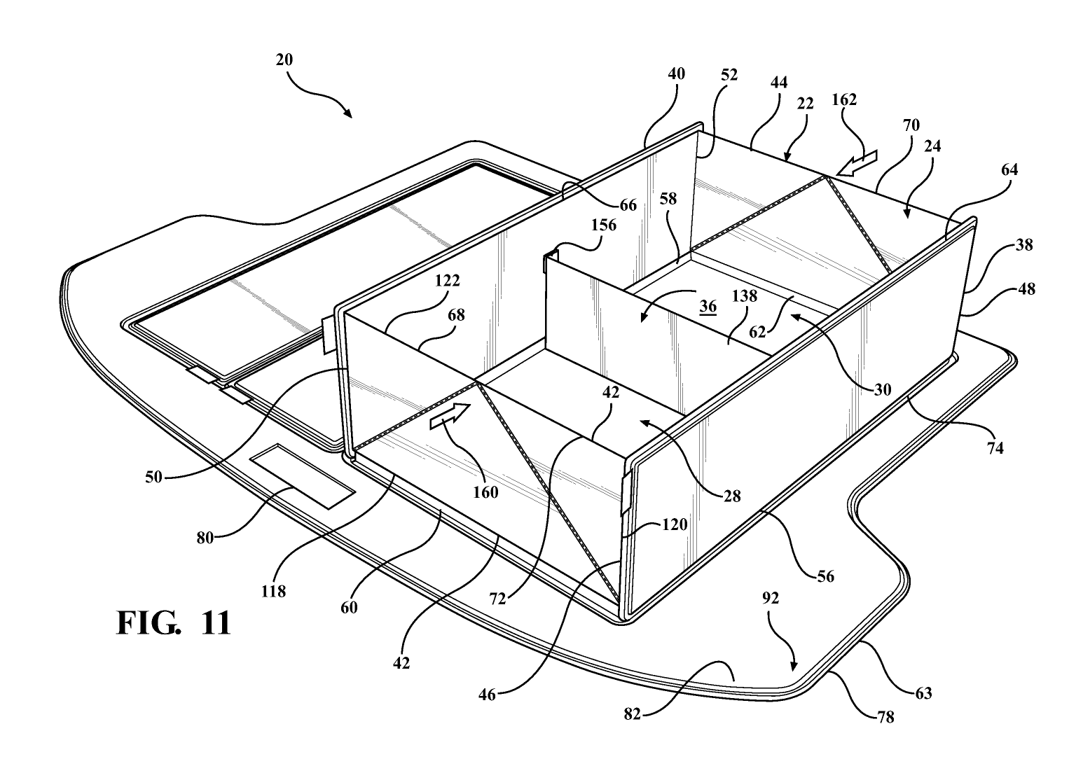

The first and second primary storage compartments 24 and 26 may be divided into two or more secondary storage compartments. For example, with reference to FIGS. 1, 7 and 10, first primary storage compartment may include a dividing wall 138 separating first primary storage compartment 24 into first secondary storage compartment 28 and second secondary storage compartment 30. Second primary storage compartment 26 may be similarly divided into multiple secondary storage compartments. Dividing wall 138 may be similarly configured as first and second end walls 42 and 44. For example, dividing wall 138 may include a divider core panel 140 constructed from a rigid or semi-rigid material, such as high-density polyethylene (HDPE). A generally flexible divider cover 142 may overlay divider core panel 140. All exposed surfaces of the divider core panel 140, including a first outer surface 144 and a second outer surface 146, may be covered by divider cover 142. Divider cover 142 may be secured in place by stitching along an outer circumference 148 of divider core panel 140. Divider cover 142 may also or alternatively be fixedly attached to divider core panel 140, for example, with an adhesive.

Divider cover 142 may be constructed from a flexible material, such as woven nylon. Other woven and non-woven materials, for example materials formed as a flexible continuous sheet, may also be employed. It is not necessary that divider cover 142 be applied to both first outer surface 144 and second outer surface 146 of divider core panel 140, and alternatively only one of the first and second outer surfaces 144 and 146 may be covered by divider cover 142.

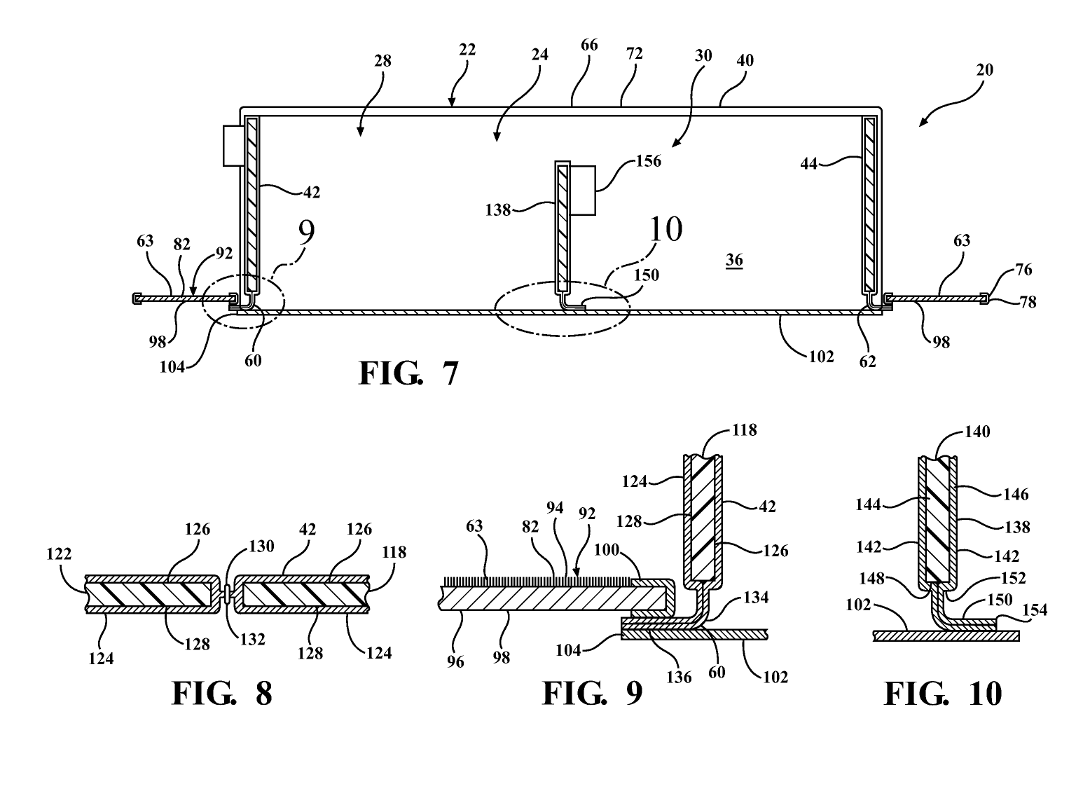

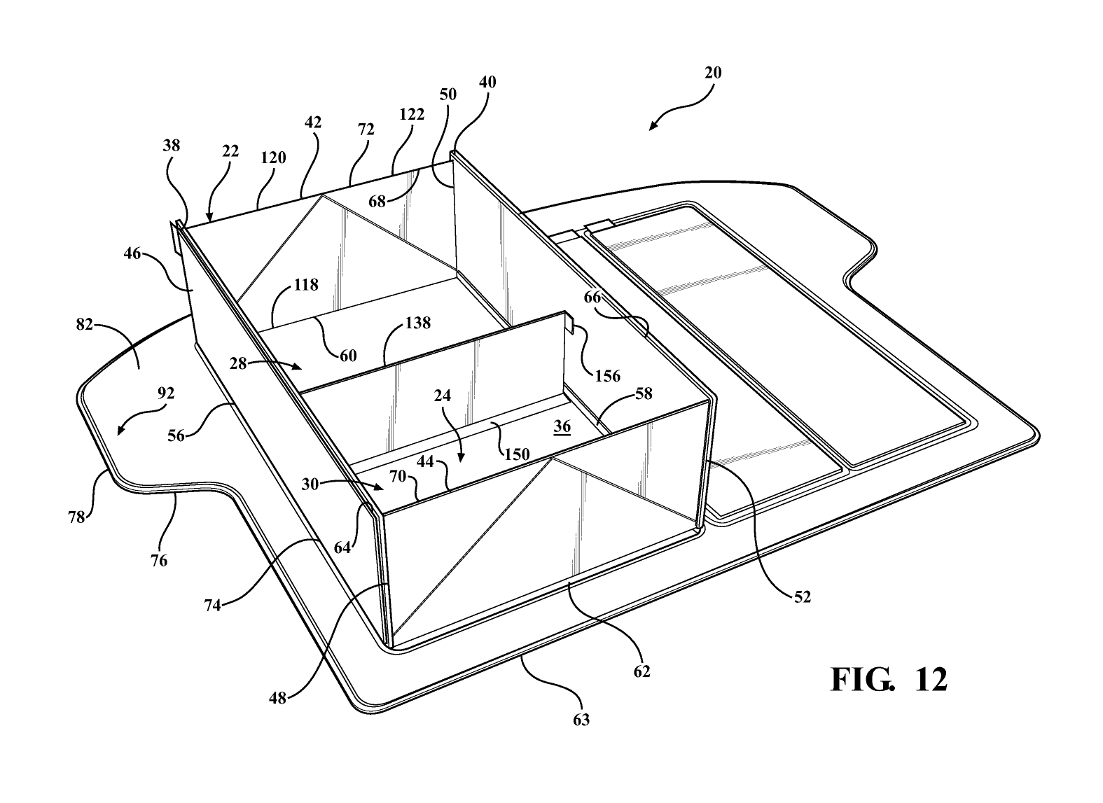

With reference to FIGS. 7, 10 and 12, dividing wall 138 may be hingeably connected to pad 102. A flexible divider hinge 150 may be used to connect a bottom edge 152 of dividing wall 138 to pad 102. Divider hinge 150 may include various configurations. For example, divider hinge 150 may be formed by extending divider cover 142 beyond bottom edge 152 of dividing wall 138. An end 154 of the excess cover material forming divider hinge 150 may be attached to pad 102 by stitching or another suitable attachment mechanism, such as an adhesive. Alternatively, divider hinge 154 may be constructed from a generally flexible resilient fabric, for example, a woven nylon material, having one end attached to dividing wall 138 and an opposite end attached to pad 102. Divider hinge 150 may extend an entire length of bottom edge 152 of dividing wall 138, or only a portion of the bottom edge.

With reference to FIGS. 1, 7 and 15, divider hinge enables dividing wall 138 to be selectively moved between an upright position, as illustrated, for example, in FIGS. 1 and 7, and a lowered position, as illustrated, for example, in FIG. 16. A releasable fastener 156 may be provided for connecting dividing wall 138 to at least one of the first and second sidewalls 38 and 40 for retaining dividing wall 138 in the upright position. The releasable fastener 156 may have any of a variety of configurations, including but not limited to, hook-and-loop fasteners, zippers, snaps, hooks, and magnets, to name a few. Other configurations of releasable connectors may also be employed. An example of a releasable fastener configuration may include a hook-and-loop fastener having a loop portion and hook portion that cooperatively engages the loop portion and which enables the two fastener portions to be repeatedly connected and disconnected from one another. The loop portion may be connected to the dividing wall 138 and the hook portion may be connected to at least one of the first and second sidewalls 38 and 40. The location of the hook and loop portions of the releasable fastener may alternatively be reversed, wherein the loop portion is attached to at least one of first and second sidewalls 38 and 40, and the hook portion is attached to dividing wall 138.

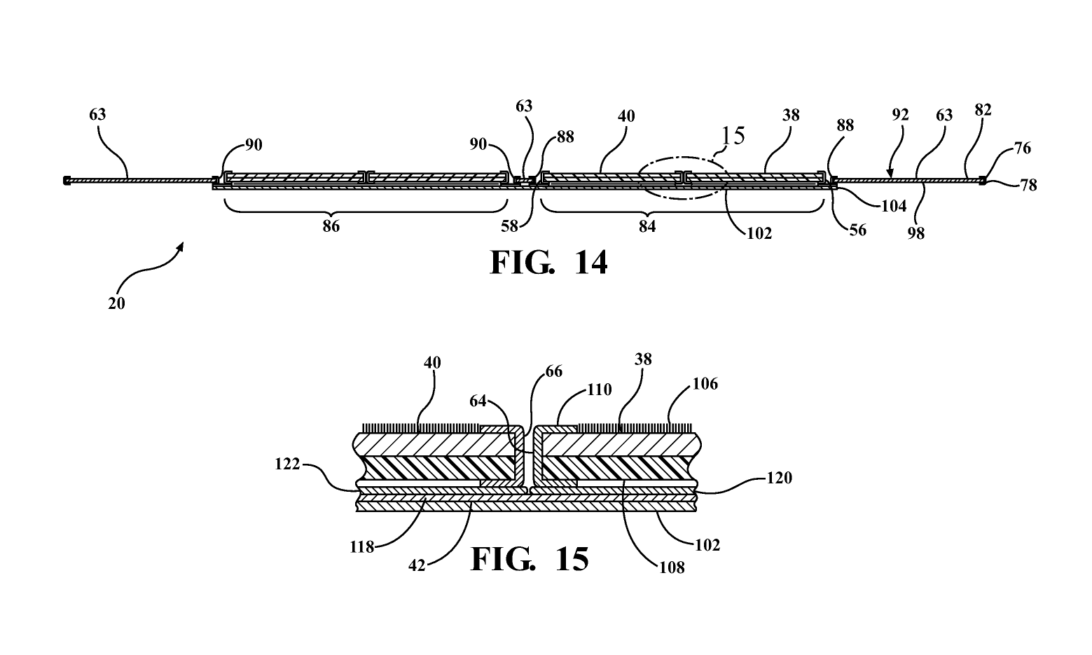

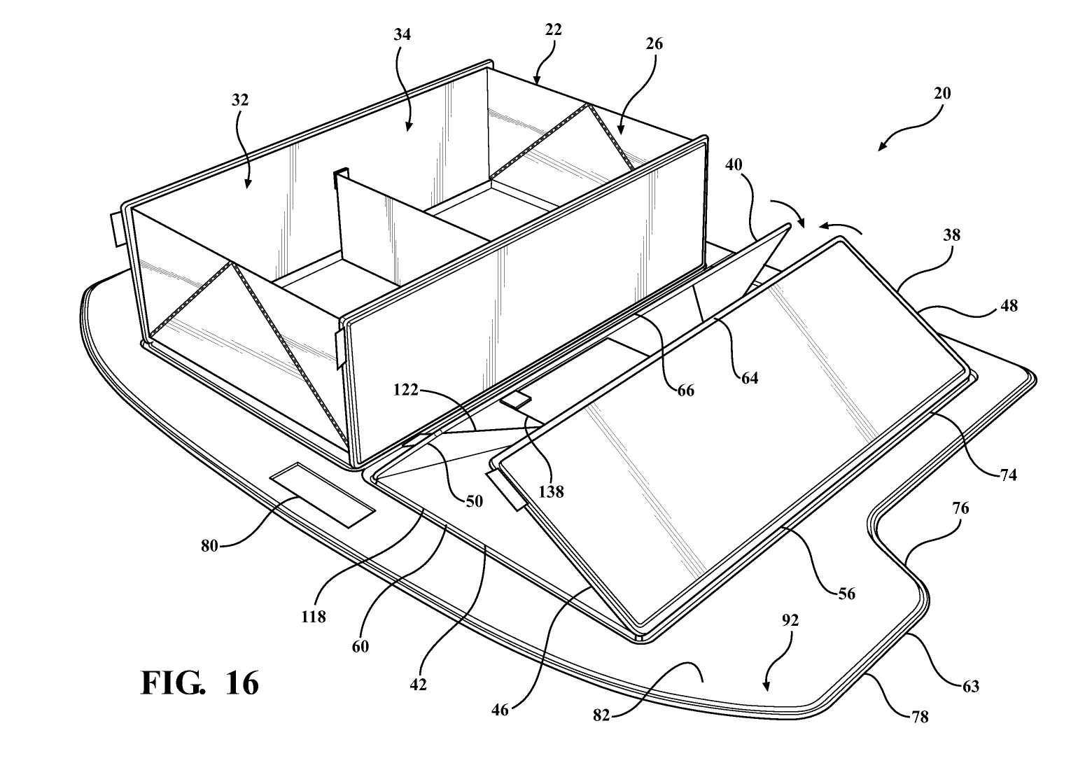

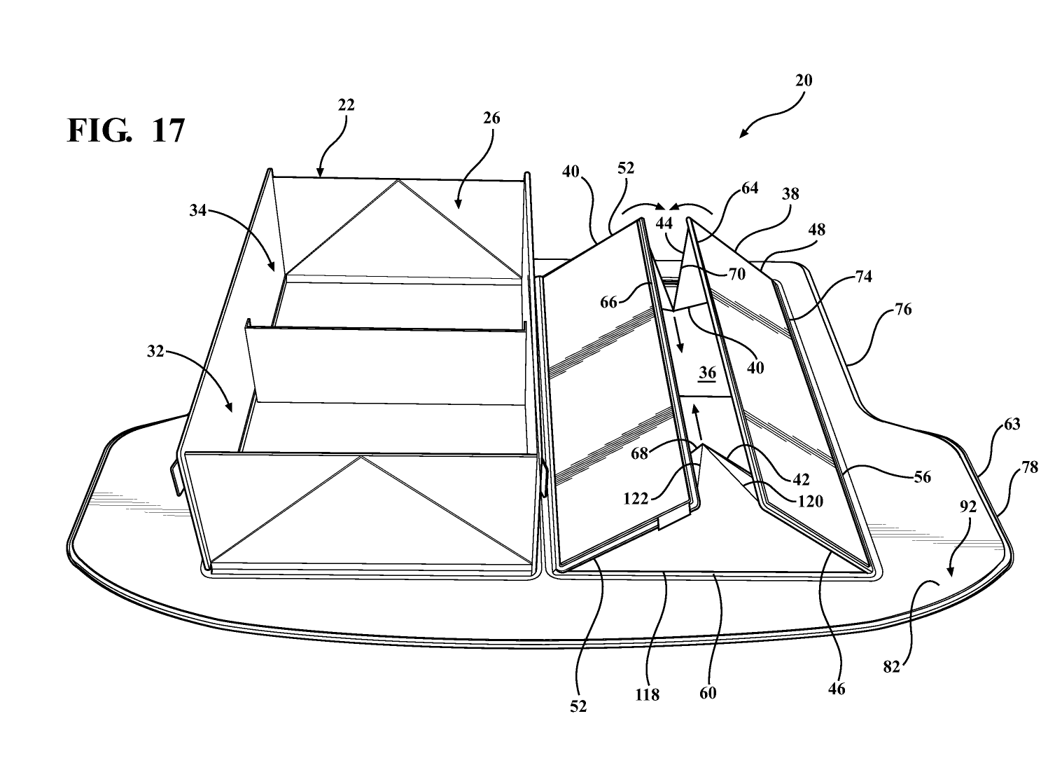

Each primary storage compartment 24 and 26 may be selectively moved between the open position, as illustrated, for example, in FIG. 1, and the closed position, as illustrated, for example, in FIG. 13. The operation of moving first primary storage compartment 24 between the open and closed positions will be described, with the understanding that second primary storage compartment 26 may be operated in a similar manner. With reference to FIGS. 1 and 11-17, first primary storage compartment 24 may be moved from the open position to the closed position by initially disconnecting releasable fastener 156. This allows dividing wall 138 to be pivoted around divider hinge 150 from the upright position to the lowered position overlaying pad 102, as illustrated, for example, in FIG. 15. With dividing wall 138 arranged in the lowered position, first and second sidewalls 38 and 40 and first and second end walls 42 and 44 may be folded toward the closed position by applying an inwardly directed force 160 and 162 to first and second end walls 42 and 44, as illustrated, for example, in FIG. 11. Applied force 160 causes core panel 118 to pivot inward about hinge 134 connected to base 63 toward the closed position, and core panels 120 and 122 to pivot about their respective hinge connections with core panel 118 and first and second sidewalls 38 and 40. Applied force 162 causes the core panels of second end wall 44 to similarly pivot about their respective hinge connections with base 63 and first and second sidewalls 38 and 40. Moving first and second end walls 42 and 44 toward the closed position causes first and second sidewalls 38 and 40 to pivot inward about hinge 112 connected to base 63 toward the closed position. The core panels 118, 120 and 122 of the first and second end walls are received within the recess formed by opening 84 in base 63 when first primary storage compartment 24 is arranged in the fully closed position.

The first and second sidewalls 38 and 40 overlay the first and second end walls 42 and 42 in a stacked arrangement when first primary storage compartment 24 is positioned in the closed position. The stacking arrangement is best viewed in FIG. 15. With the first primary storage compartment 24 arranged in the closed position, core panel 118 is arranged adjacent pad 102. Core panels 120 and 122 overlay core panel 118, such that inner surface 126 of core panels 120 and 122 are adjacent inner surface 126 of core panel 118. Core panel 118 is positioned between core panels 120 and 122 and pad 102. First sidewall 38 overlays core panel 120 and second sidewall 40 overlays core panel 122. Core panels 120 is positioned between core panel 118 and first sidewall 38 and core panel 122 is positioned between core panel 118 and second sidewall 40. Top edge 64 of first sidewall 38 is positioned immediately adjacent top edge 66 of second sidewall 40 when arranged in the closed position. The top edge 68 of core panels 120 and 122 is aligned substantially parallel with the top edge 64 of first sidewall 38 and the top edge 70 of second sidewall 40 when arranged in the closed position.

The first primary storage compartment 24 may be moved from the closed position to the open position by generally reversing the process for moving the storage compartment to the closed position. For example, first and second sidewalls 38 and 40 may be pivoted upward and outward about their respective hinge connections with base 63 toward the open position, as illustrated, for example, in FIG. 13. This in turn causes first and second end walls 42 and 44 to concurrently pivot upward and outward toward their respective open positions. The first primary storage compartment 24 may be maintained in the open position by pivoting dividing wall from its lowered position to its upright position and engaging releasable fasten 156.

It is intended that the scope of the present methods and apparatuses be defined by the following claims. However, it must be understood that the disclosed systems and methods for notifying a user of an available voice command shortcut may be practiced otherwise than is specifically explained and illustrated without departing from its spirit or scope. It should be understood by those skilled in the art that various alternatives to the configurations described herein may be employed in practicing the claims without departing from the spirit and scope as defined in the following claims. The scope of the disclosed systems and methods should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future examples. Furthermore, all terms used in the claims are intended to be given their broadest reasonable constructions and their ordinary meanings as understood by those skilled in the art unless an explicit indication to the contrary is made herein. In particular, use of the singular articles such as “a,” “the,” “said,” etc., should be read to recite one or more of the indicated elements unless a claim recites an explicit limitation to the contrary. It is intended that the following claims define the scope of the device and that the method and apparatus within the scope of these claims and their equivalents be covered thereby. In sum, it should be understood that the device is capable of modification and variation and is limited only by the following claims.

What is claimed is:

1. A collapsible cargo mat organizer, comprising:
a base;
a first sidewall including a bottom edge hingeably connected to the base and a top edge opposite the bottom edge;
a first end wall including a first core panel hingeably connected to the first sidewall and a second core panel hingeably connected to the first core panel and having a bottom edge abutting the base; and
the first sidewall pivotable between a closed position, wherein the top edge of the first sidewall is positioned adjacent the base, and an open position, wherein the top edge of the first sidewall is displaced from the base.

2. The collapsible cargo mat organizer of claim 1, wherein the first core panel is positioned between the second core panel and the first sidewall when the first sidewall is in the closed position.

3. The collapsible cargo mat organizer of claim 1, further comprising:
a second sidewall positioned opposite the first sidewall, the second sidewall including a bottom edge hingeably connected to the base and a top edge opposite the bottom edge, the second sidewall pivotable between a closed position, wherein the top edge of the second sidewall is positioned adjacent the base and abuts the top edge of the first sidewall, and an open position, wherein the top edge of the second sidewall is displaced from the base and the top edge of the first sidewall.

4. The collapsible cargo mat organizer of claim 3, wherein the first end wall further comprises a third core panel hingeably connected to the second sidewall and the second core panel, wherein the third core panel is positioned between the second core panel and the second sidewall when the second sidewall is in the closed position.

5. The collapsible cargo mat organizer of claim 3, wherein at least one of the first, second and third core panels includes a semi-rigid material.

6. The collapsible cargo mat organizer of claim 1, wherein the base includes a recessed region, the first sidewall and the second core panel located adjacent a perimeter of the recessed region, the second core panel disposed within the recessed region when the first sidewall is positioned in the closed position.

7. The collapsible cargo mat organizer of claim 6, wherein the first sidewall is at least partially positioned with the recessed region when arranged in the closed position.

8. The collapsible cargo mat organizer of claim 7, wherein an outer surface of the first sidewall and an upper surface of the base are constructed from a common material.

9. The collapsible cargo mat organizer of claim 1, wherein the second core panel is hingeably connected to the base.

10. A collapsible cargo mat organizer, comprising:
a base including a recessed region;
a first sidewall including a bottom edge hingeably connected to the base adjacent a perimeter of the recessed region and a top edge opposite the bottom edge;
a first end wall including a first core panel hingeably connected to the first sidewall and a second core panel hingeably connected to the first core panel and having a bottom edge abutting the base; and
the first sidewall pivotable between a closed position, wherein the top edge of the first sidewall is positioned adjacent the base, the second core panel is disposed within the recessed region and a top edge of the first core panel is aligned substantially parallel with the top edge of the first sidewall, and an open position, wherein the top edge of the first sidewall is displaced from the base.

11. The collapsible cargo mat organizer of claim 10, wherein the first core panel is positioned between the second core panel and the first sidewall when the first sidewall is in the closed position.

12. The collapsible cargo mat organizer of claim 10, wherein the top edge of the first sidewall abuts the top edge of the first core panel when the first sidewall is positioned in the closed position.

13. The collapsible cargo mat organizer of claim 10, further comprising:
a second sidewall positioned opposite the first sidewall, the second sidewall including a bottom edge hingeably connected to the base adjacent the perimeter of the recessed region and a top edge opposite the bottom edge, the second sidewall pivotable between a closed position, wherein the top edge of the second sidewall is positioned adjacent the base and abuts the top edge of the first sidewall, and an open position, wherein the top edge of the second sidewall is displaced from the base and the top edge of the first sidewall.

14. The collapsible cargo mat organizer of claim 13, wherein the first end wall further comprises a third core panel hingeably connected to the second sidewall and the second core panel, wherein the third core panel is disposed within the recessed region and a top edge of the third core panel is aligned substantially parallel with the top edge of the second sidewall when the second sidewall is positioned in the closed position.

15. The collapsible cargo mat organizer of claim 14, wherein the top edge of the second sidewall abuts the top edge of the third core panel when the second sidewall is positioned in the closed position.

16. The collapsible cargo mat organizer of claim 14, wherein the third core panel is positioned between the second core panel and the second sidewall when the second sidewall is in the closed position.

17. The collapsible cargo mat organizer of claim 10, wherein the second core panel is hingeably connected to the base.

18. The collapsible cargo mat organizer of claim 10, wherein at least one of the first and second sidewall includes a semi-rigid material.
